(19) United States
(12) Patent Application Publication
(10) Pub. No.: US 2009/0092867 A1
(43) Pub. Date: Apr. 9, 2009

(54) FUEL CELL SYSTEM AND METHOD FOR OPERATING A FUEL CELL SYSTEM

(75) Inventors: Takahiro SUZUKI, Tokyo (JP); Ryosuke Yagi, Tokyo (JP); Ryoichi Sebori, Tokyo (JP); Terumasa Nagasaki, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 12/204,055

(22) Filed: Sep. 4, 2008

(30) Foreign Application Priority Data
Sep. 26, 2007 (JP) 2007-249760

(51) Int. Cl. H01M 8/04; H01M 8/00

(52) U.S. Cl. 429/13; 429/24

(57) ABSTRACT

A method for operating a fuel cell system includes: disconnecting a connection between a cell and an electrical load, driving a fan and a circulation pump so as to circulate the fuel in a route from a buffer unit to the buffer unit through an anode electrode of the cell with a secondary battery when a detected amount of the fuel stored in a buffer unit is larger than a an upper-limit threshold value and a detected temperature of the cell or fuel is lower than or equal to a temperature threshold value.

The application is based upon and claims the benefit of priority from the prior Japanese Patent Applications No. P2007-249760, filed on Sep. 26, 2007, the entire contents of which are incorporated herein by reference.

### BACKGROUND OF THE INVENTION

1. Field of the Invention

The present invention relates to a fuel cell system and a method for operating the fuel cell system.

2. Description of the Related Art

In a fuel cell system, there is a known method for performing gas-liquid separation for gas (CO₂ gas) generated in an anode reaction (refer to JP-A 2002-0175817 (KOKAI)). The gas is generated from liquid fuel and water by providing a gas-liquid separation structure on the anode side of the fuel cell system. By using such a gas-liquid separation structure, it is possible to construct an anode route as a closed loop. During manufacture of the fuel cell system, it is desirable to miniaturize such a closed anode route. For achieving miniaturization of the closed anode route, it is effective to miniaturize a buffer unit, which is provided in the closed anode route and stores the fuel. The buffer is miniaturized by reducing the amount by which it is possible to buffer the fuel.

There has been proposed a method for adjusting an amount of the liquid (fuel) stored in the buffer unit by controlling temperature of a power generation unit (refer to JP-A 2007-165148 (KOKAI)). However, in the method, a case is assumed where there is a large buffer amount of the buffer unit, and a study has only been made on adjustment of the amount of liquid at the time of a rated operation. Accordingly, unless the adjustment is performed separately at the time of starting the rated operation and at the time of completion of the rated operation, the miniaturized buffer unit cannot buffer the required amount of liquid, leading to a possibility that an automatic operation may fail.

### SUMMARY OF THE INVENTION

An object of the present invention is to provide a fuel cell system and a method for operating a fuel cell system, which can adjust an amount of liquid stored in a buffer unit and thereby provide a stable operation.

An aspect of the present invention inheres in a method for operating a fuel cell system so as to drive an electrical load, the fuel cell system including: a cell including an electrolyte membrane, and an anode electrode and a cathode electrode sandwiching the electrolyte membrane, the cell to generate power so as to drive the electrical load by reaction of fuel supplied to the anode electrode with air supplied to the cathode electrode; a buffer unit to store the fuel; a liquid amount detector to detect an amount of the fuel stored in the buffer unit; a temperature detector to detect a temperature of at least one of the cell and the fuel; a circulation pump to circulate the fuel in a route from the buffer unit and returning to the buffer unit through the anode electrode; a fan to cool the cell; a fuel supply unit to supply the fuel to the route; and a secondary battery to store the power generated by the cell, the method including: setting a temperature threshold value for the detected temperature and an upper-limit threshold value for the detected amount; comparing the detected amount with the upper-limit threshold value; comparing the detected temperature with the temperature threshold value; and disconnecting a connection between the cell and the electrical load, driving the fan with the secondary battery, and driving the circulation pump so as to circulate the fuel in the route with the secondary battery when the detected amount is larger than the upper-limit threshold value and the detected temperature is lower than or equal to the temperature threshold value.

Another aspect of the present invention inheres in a method for operating a fuel cell system so as to drive an electrical load, the fuel cell system including: a cell including an electrolyte membrane, and an anode electrode and a cathode electrode sandwiching the electrolyte membrane, the cell to generate power so as to drive electrical load the by reaction of fuel supplied to the anode electrode with air supplied to the cathode electrode; a buffer unit to store the fuel; a circulation pump to circulate the fuel in a route from the buffer unit and returning to the buffer unit through the anode electrode; a fan to cool the cell; a fuel supply unit to supply the fuel to the route; and a secondary battery to store the power generated by the cell, the method including: setting a temperature threshold value for the detected temperature and an upper-limit threshold value for the detected amount; comparing the detected amount with the upper-limit threshold value; comparing the detected temperature with the temperature threshold value; disconnecting a connection between the cell and the electrical load, driving the circulation pump with the secondary battery, and driving the fan intermittently or at a lower speed than that at the time of a rated operation, when the detected temperature is higher than the temperature threshold value and the detected amount is larger than the upper-limit threshold value.

Further aspect of the present invention inheres in a fuel cell system so as to drive an electrical load, including: a cell including an electrolyte membrane, and an anode electrode and a cathode electrode sandwiching the electrolyte membrane, the cell to generate power so as to drive the electrical load by reaction of a fuel supplied to the anode electrode with air supplied to the cathode electrode; a buffer unit to store the fuel; a liquid amount detector to detect an amount of the fuel stored in the buffer unit; a temperature detector to detect a temperature of at least one of the cell and the fuel flowing in the cell; a circulation pump to circulate the fuel in a route from the buffer unit and returning to the buffer unit through the anode electrode; a fan configured to cool the cell; a fuel supply unit to supply the fuel to the route; and a secondary battery to store the power generated by the cell, and a controller to set a temperature threshold value for the detected temperature and an upper-limit threshold value for the detected amount, to compare the detected amount with the upper-limit threshold value, to compare the detected temperature with the temperature threshold value, wherein the cell and the electrical load are disconnected from each other, the secondary battery drives the fan, and the secondary battery drives the circulation pump so as to circulate the fuel in the route, when the detected amount is larger than the upper-limit threshold value and the detected temperature is lower than or equal to the temperature threshold value.

### BRIEF DESCRIPTION OF DRAWINGS

FIG. 1 is a block diagram showing an example of a fuel cell system according to a first embodiment of the present invention.

FIG. 2 is a cross-sectional view of a cell of a stack according to the first embodiment.

FIG. 3 is a cross-sectional view of a main part of the cell according to the first embodiment.

FIG. 4 is a schematic view showing an example of a buffer unit according to the first embodiment.

FIG. 5 is a schematic view showing the buffer unit storing an amount of liquid corresponding to a lower-limit value according to the first embodiment.

FIG. 6 is a schematic view the buffer unit storing an amount of liquid corresponding to an upper-limit value according to the first embodiment.

FIG. 7 is a schematic view showing an example of a power supply unit according to the first embodiment.

FIG. 8 is a flow chart for explaining an example of a method for operating the fuel cell system according to the first embodiment.

FIG. 9 is a flow chart for explaining an example of a method for operating the fuel cell system according to a second embodiment of the present invention.

### DETAILED DESCRIPTION OF THE INVENTION

Various embodiments of the present invention will be described with reference to the accompanying drawings. It is to be noted that the same or similar reference numerals are applied to the same or similar parts and elements throughout the drawings, and the description of the same or similar parts and elements will be omitted or simplified.

Generally and as it is conventional in the representation of semiconductor devices, it will be appreciated that the various drawings are not drawn to scale from one figure to another nor inside a given figure, and in particular that the layer thicknesses are arbitrarily drawn for facilitating the reading of the drawings.

In the following descriptions, numerous specific details are set fourth such as specific signal values, etc. to provide a thorough understanding of the present invention. However, it will be obvious to those skilled in the art that the present invention may be practiced without such specific details. In other instances, well-known circuits have been shown in block diagram form in order not to obscure the present invention in unnecessary detail.

### FIRST EMBODIMENT

As shown in FIG. 1, a fuel cell system according to a first embodiment of the present invention includes: a stack 100 including a cell, which has an electrolyte membrane, and an anode electrode 11a and a cathode electrode 11b, which are opposite to each other while the electrolyte membrane interposed therebetween. The cell generates power by a reaction between fuel supplied to the anode electrode 11a and air supplied to the cathode electrode 11b. A buffer unit 106 stores the fuel; and a liquid amount detector 111 detects an amount of the fuel (liquid) stored in the buffer unit 106. A temperature detector 101 detects a temperature of at least either of the stack 100 or the fuel flowing in the stack 100. A circulation pump 107 circulates the fuel through closed anode routes L1, L2, L3 and L4, which start from the buffer unit 106 and return to the buffer unit 106 through the anode electrode 11a. A fan 102 cools the stack 100 and supplies the air to the cathode electrode 11b; a fuel supply unit 110 supplies the fuel to the closed anode routes L1, L2, L3 and L4; and a secondary battery 42 stores the power generated by the stack 100.

The stack 100 and the buffer unit 106 are connected to each other by the fuel pipe L1 shown in a simplified manner by a solid line in FIG. 1. In a similar way, the buffer unit 106 and the circulation pump 107 are connected to each other by the fuel pipe L2, and the stack 100 and the circulation pump 107 are connected to each other by the fuel pipes L3 and L4. A concentration detector 108 is connected with the fuel pipes L3 and L4 located between the stack 100 and the circulation pump 107. The fuel supply unit 110 is connected to the fuel pipe L1 located between the buffer unit 106 and the stack 100.

A controller 112 is connected to the temperature detector 101, the concentration detector 108, the liquid amount detector 111, the fan 102, the fuel supply unit 110 the circulation pump 107 and the like. The controller 112 controls the fan 102, the fuel supply unit 110 the circulation pump 107 and the like in accordance with detected results by the temperature detector 101, the concentration detector 108, the liquid amount detector 111 and the like.

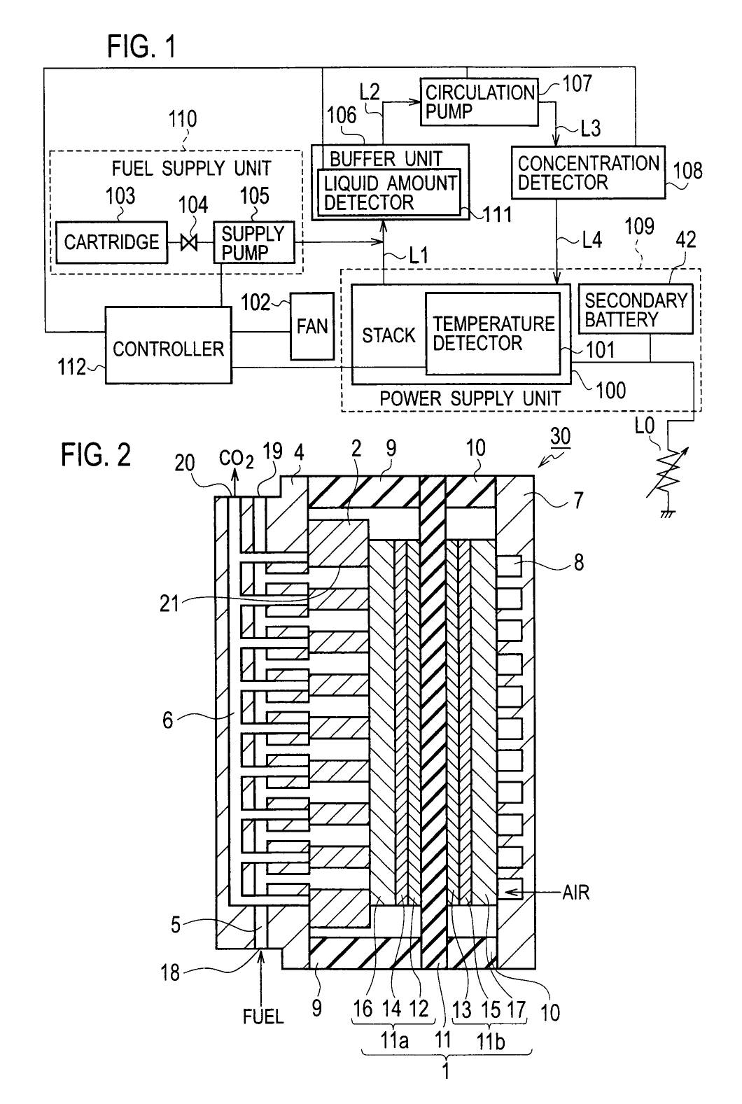

A description will be made of, as the stack 100, a stack for a direct methanol fuel cell (DMFC) using methanol as the fuel in the first embodiment. The stack 100 is composed of a plurality of cells. As shown in FIG. 2, the cell 30 includes: a membrane electrode assembly (MEA) 1 including the electrolyte membrane 11, and the anode electrode 11a and the cathode electrode 11b, which are opposite to each other while sandwiching the electrolyte membrane 11 therebetween; a gas-liquid separation layer 2 that separates fluid generated by a reaction on the anode electrode 11a into gas and liquid; and an anode flow channel plate 4 having a fuel flow passage 5 that supplies the fuel to the anode electrode 11a and a gas flow passage 6 that discharges the gas. In the membrane electrode assembly 1, the anode electrode 11a includes an anode catalyst layer 12, a carbon micro porous layer 14, and an anode gas diffusion layer 16. Moreover, the cathode electrode 11b includes a cathode catalyst layer 13, a carbon micro porous layer 15, and a cathode gas diffusion layer 17.

The electrolyte membrane 11 has a proton (H)-conductive polymer electrolyte membrane, such as a Nafion membrane (registered trademark). For the anode catalyst layer 12, for example, Pt—Ru (platinum and ruthenium) and the like can be used. For the cathode catalyst layer 13, for example, platinum (Pt) and the like can be used. For the anode gas diffusion layer 16, for example, a water repellent treatment is implemented by polytetrafluoroethylene (PTFE) for commercially available carbon paper. Commercially available carbon cloth attached to the carbon micro porous layer is usable as the cathode gas diffusion layer 17, for example. The anode gas diffusion layer 16 smoothly supplies fuel to the anode catalyst layer 12, discharges a product generated by an anode reaction, and collects current. The cathode gas diffusion layer 17 smoothly supplies air to the cathode catalyst layer 13, discharges a product generated by a cathode reaction, and collects current.

The gas/liquid separation layer 2 is provided the properties of electric conductivity, hydrophobic (water repellency), and gas permeability. A porous layer such as carbon paper, carbon cloth and carbon nonwoven fabric is usable as the gas/liquid separation layer 2.

The fuel flow channel 5 and the gas flow channel 6 are formed in the anode flow channel plate 4. The fuel flow channel 5 supplies the fuel or a fuel solution from a fuel supply port 18 to the anode electrode 11a, and discharges the fuel solution that is not reacted in the anode electrode 11a, and the like from a fuel discharge port 19. The gas flow channel 6 discharges the gas (CO₂ gas) generated by the anode reaction from a gas discharge port 20.

A cathode collector (cathode flow channel plate) 7 is disposed on an outside of the cathode gas diffusion layer 17. The cathode collector 7 supplies the air from openings 8 to the cathode electrode 11b, and collects current. An anode gasket 9 and a cathode gasket 10 prevent leakage of the fuel and the air to the outside.

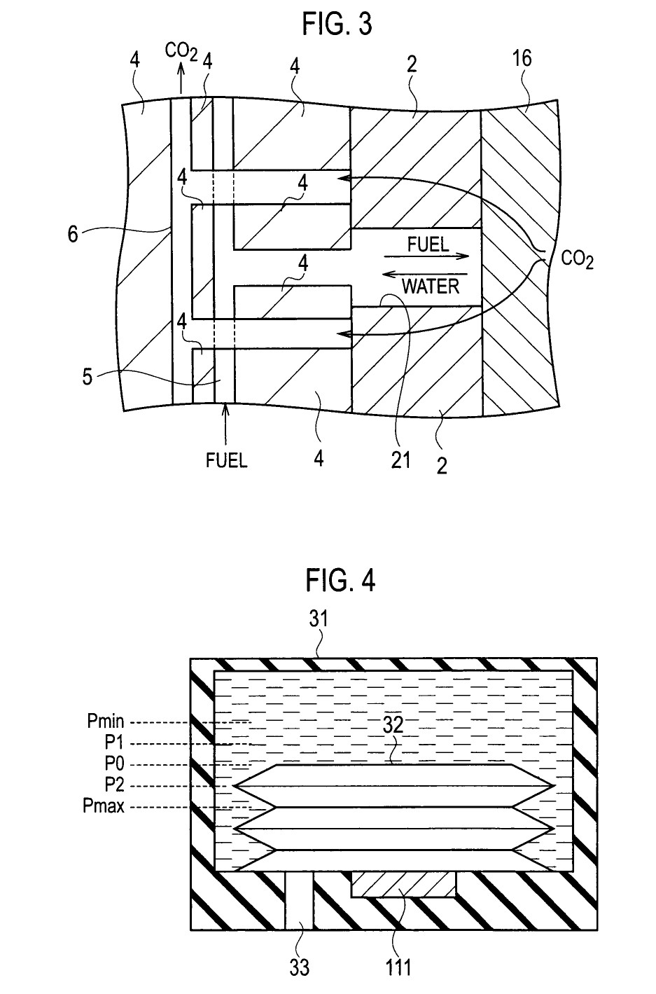

In the fuel cell system according to the first embodiment of the present invention, as shown in FIG. 3, the methanol solution passes through the fuel flow channel 5, and is supplied to the anode electrode 11a through the openings 21 of the gas/liquid separation layer 2. At the same time, air is taken in from the openings 8 of the cathode collector 7, and is supplied to the cathode electrode 11b. The reactions in the anode electrode 11a and the cathode electrode 11b are represented by reaction formulas (1) and (2), respectively.

CH₃OH+H₂O→6H⁺+6e⁻+CO₂ (1)

6H⁺+6e⁻+3/2O₂→3H₂O (2)

Protons (H⁺) generated in the anode reaction flow into the cathode electrode 11b through the electrolyte membrane 11. Electrons (e⁻) generated in the anode reaction are carried to the cathode electrode 11b via the anode flow channel plate 4, an external circuit (not shown), and the cathode collector 7. CO₂ generated in the anode reaction is more likely to pass through the lyophobic gas/liquid separation layer 2 than to form air bubbles in the liquid in the fuel flow channel 5, and accordingly, permeates the lyophobic gas/liquid separation layer 2 and the auxiliary porous layer 3, and is discharged from the gas flow channel 6. A part of the water that is not reacted in the anode electrode 11a is mixed with the methanol solution in the fuel flow channel 5, and the remainder thereof permeates the electrolyte membrane 11, and is discharged from the cathode electrode 11b to the outside. A part of the water generated in the cathode reaction is reversely diffused to the anode catalyst layer 12 side through the electrolyte membrane 11, and the rest thereof is discharged from the openings 8 of the cathode collector 7 to the outside.

In FIG. 1, the temperature detector 101 is attached to the stack 100. Note that the location of the temperature detector 101 is not particularly limited, and the temperature detector 101 may be located on the closed anode routes L1, L2, L3 and L4, and just needs to detect the temperature of the fuel circulated through the closed anode routes L1, L2, L3 and L4 or the temperature of the stack 100 (for example, surface temperature of the anode flow channel plate 4 or the cathode flow channel plate 7). The fan 102 is attached to the stack 100. The fan 102 cools the stack 100, and supplies air to the cathode electrode 11b. The circulation pump 107 circulates the fuel through the closed anode routes L1, L2, L3 and L4, thereby supplying the fuel to the stack 100, and collecting the fuel to the buffer unit 106.

The fuel supply unit 110 refills high-concentration fuel into the closed anode routes L1, L2, L3 and L4 in accordance with a concentration change in the closed anode routes L1, L2, L3 and L4. The fuel concentration change is caused by the fact that the fuel is used in the anode electrode 11a and that the liquid is increased and decreased. Thus, the fuel supply unit 110 is capable of controlling the concentration of the fuel. The fuel supply unit 110 includes: a cartridge 103 that stores the high-concentration fuel; a supply pump 105 capable of pumping the high-concentration fuel out of the cartridge 103 and supplying the high-concentration fuel to the closed anode routes L1, L2, L3 and L4; and a valve 104 capable of shutting off a connection between the cartridge 103 and the supply pump 105.

The buffer unit 106 is capable of absorbing variable amount of liquid in the closed anode routes L1, L2, L3 and L4 even if the amount of liquid are varied within a predetermined range. It is also capable of adjusting the amount of liquid in the closed anode routes L1, L2, L3 and L4 by detecting an amount of liquid stored in the buffer unit 106.

As shown in FIG. 4, the buffer unit 106 includes: a container 31; bellows 32 provided in the container 31; and the liquid amount detector 111 capable of detecting a displacement of the bellows 32. In the container 31, an inlet and outlet of the fuel, which are not shown and are connected to the fuel pipes L1 and L2, respectively, are provided. The fuel is stored in a space between the container 31 and the bellows 32. A space side of the bellows 32 is sealed with an opposite side thereof, and the opposite side communicates with the atmosphere through a hole 33. For the liquid amount detector 111, for example, an Eddy current detector being capable of detecting an amount of fuel by detecting the displacement of the bellows by a metal plate connected to the side of the bellows 32, which communicates with the atmosphere.

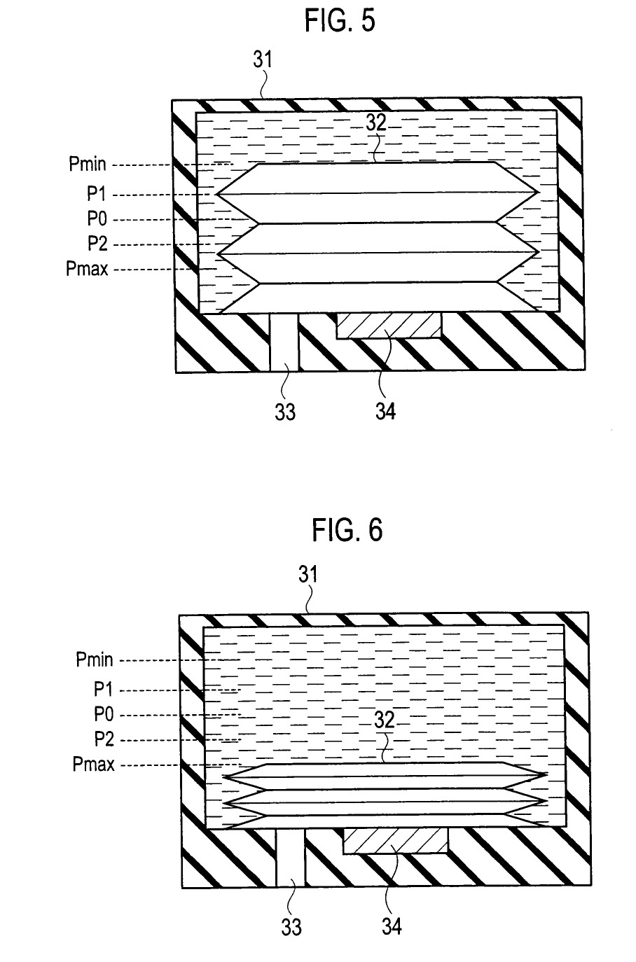

The bellows 32 have a physical restriction that is a deformation limitations of the bellows 32 and is inherent with respect to the amount of liquid storable in the buffer unit 106. Accordingly, at least one lower-limit threshold value P1 is set between a lower limit value Pmin in the deformation limitations and a center value P0, and at least one upper-limit threshold value P2 is set between an upper limit value Pmax in the deformation limitations and the center value P0. In the case where the amount of liquid is less than the lower-limit threshold value P1 as shown in FIG. 5, the amount of liquid is controlled so as to be increased. In the case where the amount of liquid is larger than the upper-limit threshold value P2 as shown in FIG. 6, the amount of liquid is controlled so as to be decreased.

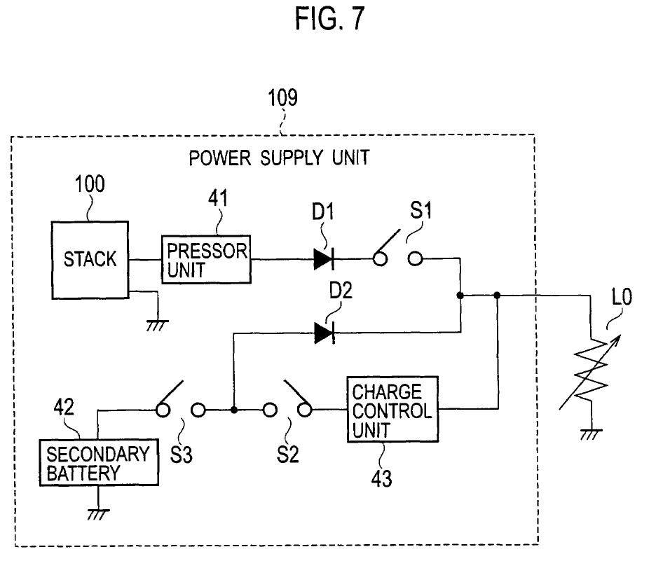

The stack 100 and the secondary battery 42, which are shown in FIG. 1, are included in a power supply unit (hybrid system) 109. As shown in FIG. 7, the power supply unit 109 further includes: a booster unit 41 connected to the stack 100; a diode D1 connected to the booster unit 41 and connected to an electrical load L0 with a switch S1 interposed therebetween; a diode D2 connected to the electrical load L0 and connected to the secondary battery 42 with a switch S3 interposed therebetween; and a charge control unit 43 connected to the diode D1 with the switch S1 interposed therebetween, connected to the secondary battery 42 with the switches S2 and S3 interposed therebetween, and connected to the electrical load L0. The stack 100 and the secondary battery 42 are OR (diode-OR)-connected to each other by the diodes D1 and D2, and are connected to the electrical load L0. The switches S1, S2 and S3 are individually switchable between on and off states. A lithium ion secondary battery (LIB) and the like may be used as the secondary battery 42. The charge control unit 43 measures an amount of battery storage of the secondary battery 42, and controls switching of the switches S1, S2, S3 and S4.

In accordance with the power supply unit 109, the electrical load L0 can be driven by switching the power generated in the stack 100 and the power stored in the secondary battery 42. Moreover, in the case where the power generated in the stack 100 is redundant with respect to the electrical load L0, the secondary battery 42 is chargeable with the redundant power. On the other hand, in the case where the power generated in the stack 100 falls short with respect to the electrical load L0, the compensating power may be supplied from the secondary battery 42.

In the fuel cell system according to the first embodiment of the present invention, an amount of water that permeates from the anode side to the cathode side changes according to the change of the temperature of the stack 100. Specifically, an amount of permeation of the water is increased as the temperature of the stack 100 is increased (for example, approximately 65° C.) more than a temperature (for example, approximately 60° C.) taken as a reference at the time of a rated operation. The amount of permeation is decreased as the temperature of the stack 100 is decreased (for example, approximately 55° C.) more than the above-described reference temperature. In consideration for these facts, the number of revolutions of the fan 102 is adjusted to a number of revolutions, which exceeds the amount of supplied air required for the reaction in the stack 100, whereby the temperature of the stack 100 can be controlled. Thus, it is possible to control the amount of water that permeates from the anode side to the cathode side, and eventually, the amount of liquid stored in the buffer unit 106. As the number of revolutions of the fan 102 is increased, a cooling effect thereof is enhanced, and the stack 100 is substantially likely to be cold. However, when the amount of air supplied thereto is increased simultaneously reaches a predetermined amount, the effect power generation is not changed very much.

Therefore, at the time of the rated operation of the fuel cell system according to the first embodiment of the present invention, in the case where the amount of liquid stored in the buffer unit 106 is detected within a range from the lower-limit threshold value P1 or more to the upper-limit threshold value P2 or less as shown in FIG. 4, the fan 102 is rotated so as not to change the amount of liquid, and the stack 100 is operated at a temperature of approximately 60° C. In the case where the amount of liquid stored in the buffer unit 106 is detected less than the lower-limit threshold value P1 as shown in FIG. 5, the number of revolutions of the fan 102 is increased so as to collect the water and to increase the amount of liquid, and the cooling effect is enhanced, whereby the temperature of the stack 100 is decreased to approximately 55° C., and the stack 100 is operated at that temperature. In the case where the amount of liquid stored in the buffer unit 106 becomes more than the upper-limit threshold value P2 as shown in FIG. 6, the number of revolutions of the fan 102 is decreased so as to increase the amount of permeation of the water and to reduce the amount of liquid, whereby the temperature of the stack 100 is increased to approximately 65° C., and the stack 100 is operated at that temperature. As described above, the temperature is adjusted based on the detected amount of liquid, so as to control the amount of liquid.

Here, before the rated operation, actually, the fuel cell system according to the first embodiment must be subjected to a temperature-elevating process that ranges from a start of the operation to a point where the temperature of the stack 100 reaches an operating temperature. In the majority of cases, during this period, the temperature is at a temperature lower than that at the time of the rated operation, and it is difficult to properly control a decrease in the amount of liquid stored in the buffer unit 106 by merely adjusting the temperature. Moreover, it is possible to decrease the amount of liquid stored in the buffer unit 106 by permitting an operation to drain the liquid to the outside, for example, to collect the liquid to an empty cartridge 103. However, such a method is not realistic in terms of the specifications of the product.

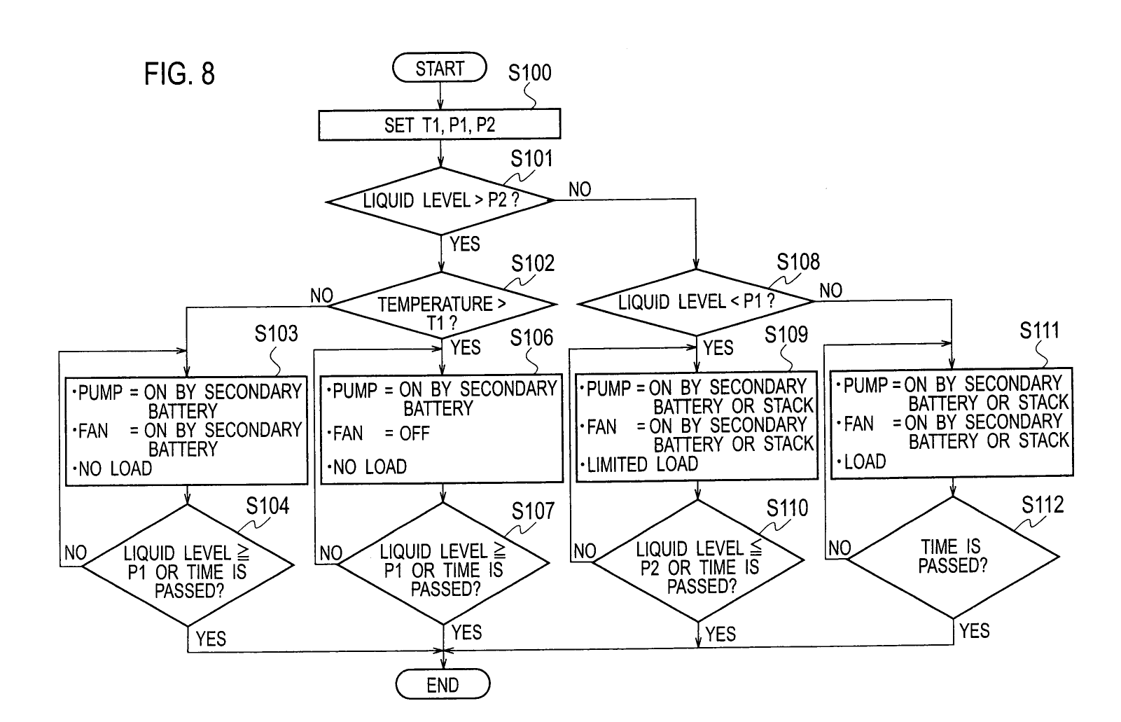

Next, a description will be made of a method for operating the fuel cell system before beginning a rated operation according to the first embodiment of the present invention, referring to a flowchart of FIG. 8.

In Step S100 for the amount of fuel stored in the buffer unit 106, which is detected by the liquid amount detector 111, the lower-limit threshold value P1 is set between the lower limit value Pmin and the center value P0, and the upper-limit threshold value P2 is set between the upper limit value Pmax and the center value P0. A temperature threshold value T1 (for example, approximately 30 to 40° C.) is set for the temperature of the stack 100 or the fuel, which is detected by the temperature detector 101. The lower-limit threshold value P1, the upper-limit threshold value P2 and the temperature threshold value T1 are appropriately settable in response to the product and a situation.

In Step S101, during the temperature-elevating process before the start of the rated operation, the controller 112 compares the amount of liquid detected by the liquid amount detector 111 with the upper-limit threshold value P2. In the case where the amount of liquid detected by the liquid amount detector 111 is larger than the upper-limit threshold value P2 as shown in FIG. 6, the processing proceeds to Step S102. In the case where the amount of liquid detected by the liquid amount detector 111 is equal to or less than the upper-limit threshold value P2 as shown in FIG. 5, the processing proceeds to Step S108.

In Step S102, the controller 112 compares the temperature detected by the temperature detector 101 with the temperature threshold value T1. In the case where the detected temperature is lower than or equal to the temperature threshold value T1, an operation to hold an open circuit voltage (OCV) is performed in Step S103. Specifically, the connection between the stack 100 and the electrical load L0 is set to a cut-off state (is disconnected), the fan 102 is operated by the power from the secondary battery 42, and the circulation pump 107 is driven by the power from the secondary battery 42, whereby the fuel is circulated through the closed anode routes L1, L2, L3 and L4. The fuel is circulated through the closed anode routes L1, L2, L3 and L4, whereby the amount of liquid stored in the buffer unit 106 can be positively decreased, and in addition, the amount of liquid can be decreased by using a characteristic that the amount of permeation of the water is increased at the time of no electrical load. When a fixed time has elapsed or the amount of liquid has reached the upper-limit threshold value P2 or less in Step S104, the processing is ended. Thereafter, the rated operation is started when the temperature conditions and the like are ready.

In Step S102, in the case where the temperature detected by the temperature detector 101 is higher than the temperature threshold value T1, then, in Step S106, the connection between the stack 100 and the electrical load L0 is set to the cut-off state, and the circulation pump 107 is driven while the fan 102 is stopped, whereby the fuel is circulated through the closed anode routes L1, L2, L3 and L4. The fuel is circulated through the closed anode routes L1, L2, L3 and L4, whereby the amount of liquid stored in the buffer unit 106 can be positively decreased, and in addition, the amount of liquid can be decreased by using the characteristic that the amount of permeation of the water is increased at the time of no electrical load. When a fixed time has elapsed or the amount of liquid has reached the upper-limit threshold value P2 or less in Step S107, the processing is ended.

In Step S108, the controller 112 compares the amount of liquid detected by the liquid amount detector 111 with the lower-limit threshold value P1. In the case where the amount of liquid detected by the liquid amount detector 111 is less than the lower-limit threshold value P1, then, in Step S109, the fan 102 is operated by power from the stack 100 or the secondary battery 42, and the circulation pump 107 is driven. As a result, the fuel is circulated through the closed anode routes L1, L2, L3 and L4, and the electrical load L0 is driven while limiting (restricting) an upper limit of a current value flowing between the stack 100 and the electrical load L0. The electrical load L0 is driven so that the amount of permeation of the water is decreased, and the amount of liquid stored in the buffer unit 106 can be increased. Moreover, the electrical load L0 is limited and the time required for elevating the temperature of the stack 100 to a temperature at the time of the rated operation is increased, and the amount of liquid can be increased. When a fixed time has elapsed or the amount of liquid has reached the upper-limit threshold value P2 or less in Step S110, the processing is ended.

In the case where the amount of liquid detected by the liquid amount detector 111 in Step S108 is equal to or larger than the lower-limit threshold value P1, the controller 112 determines that the amount of liquid stored in the buffer unit 106 is appropriate for the rated operation. Therefore, in Step S111, the fan 102 is driven by the power from the stack 100 or the secondary battery 42, and the circulation pump 107 is driven thereby, so that the fuel is circulated through the closed anode routes L1, L2, L3 and L4. Then, the electrical load L0 is driven by the power from the stack 100 or the secondary battery 42. When a fixed time has elapsed in Step S112, the processing is ended.

In accordance with the first embodiment of the present invention, in the case where the temperature of the stack 100 is low, for example, before the start of the rated operation, it is possible to maintain the amount of liquid stored in the buffer unit 106 within an appropriate range in response to the lower-limit threshold value P1, the upper-limit threshold value P2 and the temperature threshold value T1.

Moreover, step-by-step operations such as adjusting the number of revolutions of the fan 102 finely may be taken in such a manner that, with regard to the fuel stored in the buffer unit 106, a plurality of the lower-limit threshold values P1 are set between the lower limit value Pmin and the center value P0, and a plurality of the upper-limit threshold values P2 are set between the upper limit value Pmax and the center value P0, and moreover, a plurality of the temperature threshold values T1 are set.

### SECOND EMBODIMENT

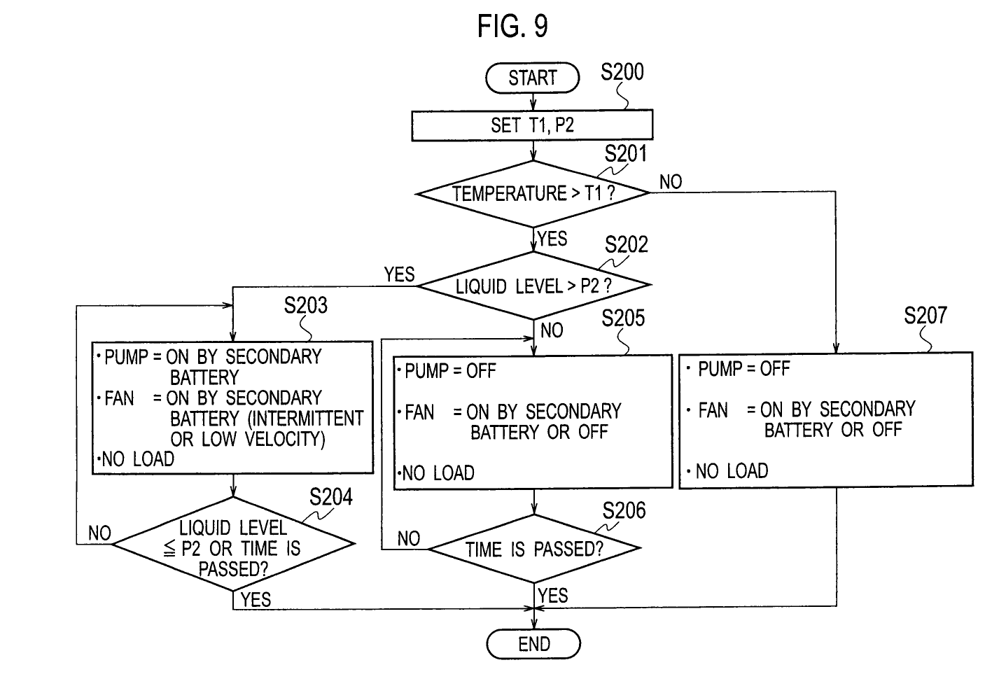

A fuel cell system according to a second embodiment of the present invention is substantially similar in configuration to that shown in FIG. 1, and accordingly, a duplicate description will be omitted. A description will be made of a method for operating the fuel cell system after completion of rated operation according to the second embodiment of the present invention, referring to a flowchart of FIG. 9.

In Step S200, for the amount of fuel stored in the buffer unit 106, the upper-limit threshold value P2 is set between the upper limit value Pmax and the center value P0, and the temperature threshold value T1 is set for the temperature of the stack 100.

After the end of the rated operation, in Step S201, the controller 112 compares the temperature detected by the temperature detector 101 with the temperature threshold value T1. In the case where the temperature detected by the temperature detector 101 is higher than the temperature threshold value T1, the processing proceeds to Step S202, and in the case where the temperature detected by the temperature detector 101 is equal to or lower than the temperature threshold value T1, the processing proceeds to Step S207.

In Step S202, the controller 112 compares the amount of liquid detected by the liquid amount detector 111 with the upper-limit threshold value P2. In the case where the amount of liquid detected by the liquid amount detector 111 is larger than the upper-limit threshold value P2 as shown in FIG. 6, the processing proceeds to Step S203, and in the case where the amount of liquid detected by the liquid amount detector 111 is equal to or less than the upper-limit threshold value P2, the processing proceeds to Step S205.

In Step S203, the circulation pump 107 is driven by obtaining power from the secondary battery 42 in a state where the connection between the electrical load L0 and the stack 100 is cut off, whereby the fuel is circulated through the closed anode routes L1, L2, L3 and L4, and the amount of liquid stored in the buffer unit 106 can be positively decreased. Moreover, by obtaining power from the secondary battery 42, the fan 102 is operated intermittently or at a lower speed than that at the time of the rated operation of the fuel cell system. The fan 102 is operated so that dew (moisture) condensation can be prevented from occurring at an exhaust port and the like. When a fixed time has elapsed or the amount of liquid has reached the upper-limit threshold value P2 or less in Step S204, the processing is ended.

In Step S205, the circulation pump 107 is stopped in the state where the connection between the electrical load L0 and the stack 100 is cut off. The fan 102 is operated at a higher speed than in the case of Step S203 by the secondary battery 42, or the fan 102 is stopped. In the case of operating the fan 102, the condensation can be prevented from occurring at the exhaust port and the like. When a fixed time has elapsed in Step S206, the processing is ended.

In Step S207, the circulation pump 107 is stopped in the state where the connection between the electrical load L0 and the stack 100 is cut off. The fan 102 is steadily operated by the secondary battery 42, or the fan 102 is stopped. In the case of operating the fan 102, the condensation can be prevented from occurring at the exhaust port and the like.

In accordance with the second embodiment of the present invention, at the time of ending the operation, it is possible to appropriately adjust the amount of liquid stored in the buffer unit 106. In such a way, in the case of performing the rated operation one more time, the operation can be resumed with ease.

### OTHER EMBODIMENTS

Various modifications will become possible for those skilled in the art after receiving the teachings of the present disclosure without departing from the scope thereof.

It is possible to combining the operation method before rated operation according to the first embodiment of the present invention and the operation method after rated operation according to the second embodiment of the present invention.

Furthermore, the operation method according to the first embodiment of the present invention is explained as a method before rated operation and the operation method according to the second embodiment of the present invention is explained as a method after rated operation. However, the operation methods according to the first and second embodiments of the present invention may be performed during rated operation.

Furthermore, various alcohols, ethers or the like instead of methanol may be used as the fuel of the first and second embodiments of the present application.

What is claimed is:

1. A method for operating a fuel cell system so as to drive an electrical load, the fuel cell system comprising:
a cell comprising
an electrolyte membrane, and
an anode electrode and a cathode electrode sandwiching the electrolyte membrane,
the cell to generate power so as to drive the electrical load by reaction of a fuel supplied to the anode electrode with air supplied to the cathode electrode;
a buffer unit to store the fuel;
a liquid amount detector to detect an amount of the fuel stored in the buffer unit;
a temperature detector to detect a temperature of at least one of the cell and the fuel flowing in the cell;
a circulation pump to circulate the fuel in a route from the buffer unit and returning to the buffer unit through the anode electrode;
a fan configured to cool the cell;
a fuel supply unit to supply the fuel to the route; and
a secondary battery to store the power generated by the cell,
the method comprising:
setting a temperature threshold value for the detected temperature and an upper-limit threshold value for the detected amount;
comparing the detected amount with the upper-limit threshold value;
comparing the detected temperature with the temperature threshold value; and
disconnecting a connection between the cell and the electrical load, driving the fan with the secondary battery, and driving the circulation pump so as to circulate the fuel in the route with the secondary battery when the detected amount is larger than the upper-limit threshold value and the detected temperature is lower than or equal to the temperature threshold value.

2. The method of claim 1, further comprising:
disconnecting a connection between the cell and the electrical load, stopping the fan, and driving the circulation pump so as to circulate the fuel in the route with the secondary battery, when the detected amount is larger than the upper-limit threshold value and the detected temperature is higher than the temperature threshold value.

3. The method of claim 1, further comprising:
setting a lower-limit threshold value for the detected amount;
comparing the detected amount with the lower-limit threshold value; and
driving the fan with the secondary battery, driving the circulation pump so as to circulate the fuel in the route with the secondary battery, and driving the electrical load with the secondary battery so as to limit an upper-limit of current value between the cell and the electrical load, when the detected amount is less than the lower-limit threshold value.

4. The method of claim 1, further comprising:
setting a lower-limit threshold value for the detected amount;
comparing the detected amount with the lower-limit threshold value;
driving the fan with the cell, driving the circulation pump so as to circulate the fuel in the route with the cell, and driving the electrical load with the cell so as to limit the upper-limit of current value between the cell and the electrical load, when the detected amount is less than the lower-limit threshold value.

5. The method of claim 3, further comprising:
driving the fan with the secondary battery, driving the circulation pump with the secondary battery so as to circulate the fuel in the route, and driving the electrical load, when the detected amount is less than the lower-limit threshold value.

6. The method of claim 3, further comprising:
driving the fan with the cell, driving the circulation pump with the cell so as to circulate the fuel in the route, and driving the electrical load with the cell, when the detected amount is less than the lower-limit threshold value.

7. The method of claim 1, wherein:
disconnecting a connection between the cell and the electrical load and driving the fan and the circulation pump with the secondary battery before rated operation of the fuel cell system.

8. A method for operating a fuel cell system so as to drive an electrical load, the fuel cell system comprising:
a cell comprising
an electrolyte membrane, and
an anode electrode and a cathode electrode sandwiching the electrolyte membrane,
the cell to generate power so as to drive electrical load the by reaction of fuel supplied to the anode electrode with air supplied to the cathode electrode;
a buffer unit to store the fuel;
a liquid amount detector to detect an amount of the fuel stored in the buffer unit;
a temperature detector to detect a temperature of at least one of the cell and the fuel flowing in the cell;
a circulation pump to circulate the fuel in a route from the buffer unit and returning to the buffer unit through the anode electrode;
a fan to cool the cell;
a fuel supply unit to supply the fuel to the route; and
a secondary battery to store the power generated by the cell,
the method comprising:
setting a temperature threshold value for the detected temperature and an upper-limit threshold value for the detected amount;
comparing the detected amount with the upper-limit threshold value;
comparing the detected temperature with the temperature threshold value;
disconnecting a connection between the cell and the electrical load, driving the circulation pump with the secondary battery, and driving the fan intermittently or at a lower speed than that at the time of a rated operation, when the detected temperature is higher than the temperature threshold value and the detected amount is larger than the upper-limit threshold value.

9. The method of claim 8, further comprising:
disconnecting a connection between the cell and the electrical load, stopping the circulation pump, and driving the fan with the secondary battery at a higher speed than that in the case when the detected temperature is higher than the temperature threshold value and the detected amount is larger than the upper-limit threshold value, when the detected temperature is higher than the temperature threshold value and the detected amount is less than or equal to the upper-limit threshold value.

10. The method of claim 8, further comprising:
disconnecting a connection between the cell and the electrical load and stopping the circulation pump and the fan, when the detected temperature is higher than the temperature threshold value and the detected amount is less than or equal to the upper-limit threshold value.

11. The method of claim 8, further comprising:
disconnecting a connection between the cell and the electrical load, stopping the circulation pump and the fan, when the detected temperature is lower than or equal to the temperature threshold value.

12. The method of claim 8, further comprising:
disconnecting a connection between the cell and the electrical load, stopping the circulation pump, and driving the fan with the secondary battery, when the detected temperature is lower than or equal to the temperature threshold value.

13. The method of claim 8, wherein
disconnecting a connection between the cell and the electrical load and driving the circulation pump and the fan with the secondary battery after rated operation of the fuel cell system.

14. A fuel cell system so as to drive an electrical load, comprising:
a cell comprising
an electrolyte membrane, and
an anode electrode and a cathode electrode sandwiching the electrolyte membrane,
the cell to generate power so as to drive the electrical load by reaction of a fuel supplied to the anode electrode with air supplied to the cathode electrode;
a buffer unit to store the fuel;
a liquid amount detector to detect an amount of the fuel stored in the buffer unit;
a temperature detector to detect a temperature of at least one of the cell and the fuel flowing in the cell;
a circulation pump to circulate the fuel in a route from the buffer unit and returning to the buffer unit through the anode electrode;
a fan configured to cool the cell;
a fuel supply unit to supply the fuel to the route; and
a secondary battery to store the power generated by the cell, and
a controller to set a temperature threshold value for the detected temperature and an upper-limit threshold value for the detected amount, to compare the detected amount with the upper-limit threshold value, and to compare the detected temperature with the temperature threshold value,
wherein the cell and the electrical load are disconnected from each other, the secondary battery drives the fan, and the secondary battery drives the circulation pump so as to circulate the fuel in the route, when the detected amount is larger than the upper-limit threshold value and the detected temperature is lower than or equal to the temperature threshold value.

15. The system of claim 14, wherein:
the cell and the electrical load are disconnected from each other, the fan is stopped, and the secondary battery drives the circulation pump so as to circulate the fuel in the route, when the detected amount is larger than the upper-limit threshold value and the detected temperature is higher than the temperature threshold value.

16. The system of claim 14, wherein:
the controller sets a lower-limit threshold value for the detected amount; and compares the detected amount with the lower-limit threshold value; and
the secondary battery drives the fan, the secondary battery drives the circulation pump so as to circulate the fuel in the route, the secondary battery drives the electrical load so as to limit an upper-limit of current value between the cell and the electrical load, when the detected amount is less than the lower-limit threshold value.

17. The system of claim 14, wherein:
the controller sets a lower-limit threshold value for the detected amount, and compares the detected amount with the lower-limit threshold value,
the cell drives the fan, the cell drives the circulation pump so as to circulate the fuel in the route, and the cell drives the electrical load so as to limit the upper-limit of current value between the cell and the electrical load, when the detected amount is less than the lower-limit threshold value.

18. The system of claim 16, further comprising:
the secondary battery drives the fan and the electrical load, and the secondary battery drives the circulation pump so as to circulate the fuel in the route, when the detected amount is less than the lower-limit threshold value.

19. The system of claim 16, further comprising:
the cell drives the fan and the electrical load, and the cell drives the circulation pump so as to circulate the fuel in the route, when the detected amount is less than the lower-limit threshold value.

20. The system of claim 14, wherein:
the cell and the electrical load are electrically disconnected from each other and the secondary battery drives the fan and the circulation pump, before rated operation of the fuel cell system.
